(19) United States
(12) Patent Application Publication
(10) Pub. No.: US 2006/0107492 A1
(43) Pub. Date: May 25, 2006

(54) ROTARY HINGE FOR ROTATIONALLY COUPLING IMAGE CAPTURING DEVICE WITH DISPLAY PANEL

(76) Inventors: Sheng-Hao Chang, Taichung County (TW); Chien-Nan Kao, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,752

(22) Filed: Nov. 25, 2004

(51) Int. Cl. E05D 3/10

(52) U.S. Cl. 16/367

(57) ABSTRACT

A rotary hinge suitable for coupling a first device with a second device is disclosed. The rotary hinge has a first axially extending pivot for coupling the first device, and a second axially extending pivot extending from the first pivot, for coupling the second device. The first device can be rotated about the first axially extending pivot or the second axially extending pivot relative to the second device. Two ratchet wheels can be mounted on the first pivot and one of them can be reciprocated along the first pivot. Two plates can be mounted on the second pivot and one of them can be reciprocated along the second pivot.

### BACKGROUND OF THE INVENTION

1. Field of Invention

The present invention relates generally to a rotary hinge for rotationally coupling an image-capturing device with a display panel. More particularly, the present invention relates to a rotary hinge that is rotated with a click feeling and can be automatically stopped at some predetermined angles.

2. Description of Related Art

Presently, image capturing devices, such as camera, digital video (DV) device and so on, are popular and are commonly used in our daily life. Typically, an image-capturing device is provided on a display panel for displaying captured images. A rotary hinge is used for coupling the display panel with the image-capturing device, thereby the display panel can be rotated relative to the image-capturing device. When the image-capturing device is shooting some pictures, the display panel can be rotated relative to the image-capturing device such that a user can watch the screen of the display panel. When the image-capturing device do not shoot pictures, the display panel can be rotated relative to the image-capturing device such that the display panel can be folded on the image-capturing device.

However, the aforementioned conventional rotary hinge for coupling the image-capturing device with the display device has several shortcomings as described below. The angle between the display panel and the image-capturing device provided by the aforementioned rotary hinge is maximized at only 90 degrees, that is not enough for a user to comfortably watch the screen on the display panel during shooting pictures. Moreover, when the display panel is being rotated relative to the image-capturing device, the display panel is not automatically stopped at a determined angle and the cabal connecting the display panel with the image-capturing device is easily pulled apart.

### SUMMARY OF THE INVENTION

Accordingly, the present invention has an objective to provide a rotary hinge for rotationally coupling an image-capturing device with a display panel. The rotary hinge can be rotated with a click feeling and can be automatically stopped at some predetermined angles.

To achieve the above and other objectives, the present invention provides a rotary hinge for rotationally coupling a first device, such as image-capturing device, with a second device, such as display panel. In one embodiment of the present invention, the rotary hinge comprises a first axially extending pivot, a first ratchet wheel, a spring, a second ratchet wheel and a second axially extending pivot. The first pivot having a spring stop is mounted on the first device. The first ratchet wheel is mounted on the first pivot and capable of sliding in an axial direction of said first pivot. The second axially extending pivot connects the first pivot with the second device. The first ratchet wheel has a first annular region and multiple first protrusions. The first protrusions project from the first annular region in the axial direction of said first pivot. The spring is positioned around the first pivot between the spring stop and the first ratchet. The second ratchet wheel is mounted on the first pivot. The second ratchet wheel contacts with the first ratchet wheel. The second ratchet wheel has a second annular region and second protrusions. The second protrusions project from the second annular region in the axial direction of the first pivot. The first ratchet wheel is capable of rotating relative to the second ratchet wheel with the first protrusions rotating over the second annular region and with the second protrusions rotating over the first annular region.

In the above rotary hinge, the first ratchet wheel moves reciprocally and axially along the first pivot when the first pivot is rotated with the first protrusions moving on the second protrusions or moving to the region between the second protrusions. Because the first protrusions have a sharp tip, the first ratchet wheel can be automatically rotated to a stable condition that the second protrusions are positioned at the lowest region between the first protrusions. Therefore, rotating the second device relative to the first device can be automatically stopped at some predetermined angles dependent on where the first protrusions are positioned on the first ratchet wheel. The action between the first and second ratchet wheels as the second device is rotated about the first pivot relative to the first device will provide a click feeling to the user.

In another embodiment of the present invention, the rotary hinge comprises a first axially extending pivot, a second axially extending pivot, a first plate and a second plate. The first pivot comprises a pedestal and is mounted to the first device. The second pivot extends through the first pivot and connects with the second device. The first plate is mounted on the pedestal of the first pivot and has multiple angular positioning holes. The second pivot extends through the first plate. The second plate is mounted on the first plate and is fixed on the second pivot. The second plate has at least a protrusion projecting from a surface of the second plate in an axial direction of the second pivot. The protrusion can be rotated over the first plate in response to the rotation of the second pivot or can be inserted into at least one of said angular positioning holes of said first plate.

In the above rotary hinge, the protrusions of the second plate can be rotated over the first plate in response to the rotation of the pivot, or can be inserted into at least one of the angular positioning holes of the first plate. Therefore, rotation of the second device about the second pivot can be stopped as the protrusion of the second plate is inserted into the angular positioning holes and can be stopped at some predetermined angles dependent on where the angular positioning holes are positioned in the first plate. As the second device rotates about the second pivot, the action between the first and second plates will provide a click feeling to the user.

In another embodiment of the present invention, the rotary hinge comprises a first axially extending pivot, a second axially extending pivot, a first plate and a second plate. The first pivot comprises a pedestal and is mounted to the first device. The second pivot extends through the first pivot and connects with the second device. The first plate is mounted on the pedestal of the first pivot, and the second pivot extends through the first plate. The first plate has at least a protrusion projecting from a surface of the first plate in an axial direction of the second pivot. The second plate is mounted on the first plate and fixed on the second pivot. The second plate has multiple angular positioning holes. The protrusion of the first plate can be rotated over the second plate in response to the rotation of the second pivot or can be inserted into at least one of the angular positioning holes of the second plate.

In the above rotary hinge, the first plate may comprise a disk spring, for example. The protrusions of the first plate can be rotated over the second plate in response to the rotation of the pivot, or can be inserted into at least one of the angular positioning holes of the second plate. Therefore, rotation of the second device about the second pivot can be stopped as the protrusion of the first plate is inserted into the angular positioning holes and can be stopped at some predetermined angles dependent on where the angular positioning holes are positioned in the second plate. As the second device rotates about the second pivot, the action between the first and second plates will provide a click feeling to the user.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective exploded view showing components of a rotary hinge according to a first embodiment of the present invention.

FIG. 2 is a schematic perspective view showing a rotary hinge coupling a display panel with an image-capturing device according to a first embodiment of the present invention.

FIG. 3 is a schematic perspective magnified view showing a ratchet wheel 130 according to a first preferred embodiment of the present invention.

FIG. 4 is a schematic perspective magnified view showing a ratchet wheel 140 according to a first embodiment of the present invention.

FIG. 5 is a schematic perspective magnified view showing a plate 170 according to a first embodiment of the present invention.

FIG. 6 is a schematic perspective view showing a rotary hinge coupling a display panel with an image-capturing device according to a second embodiment of the present invention.

FIG. 7 is a schematic perspective magnified view showing a plate 260 according to a second embodiment of the present invention.

FIG. 8 is a schematic perspective magnified view showing a plate 270 according to a second embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

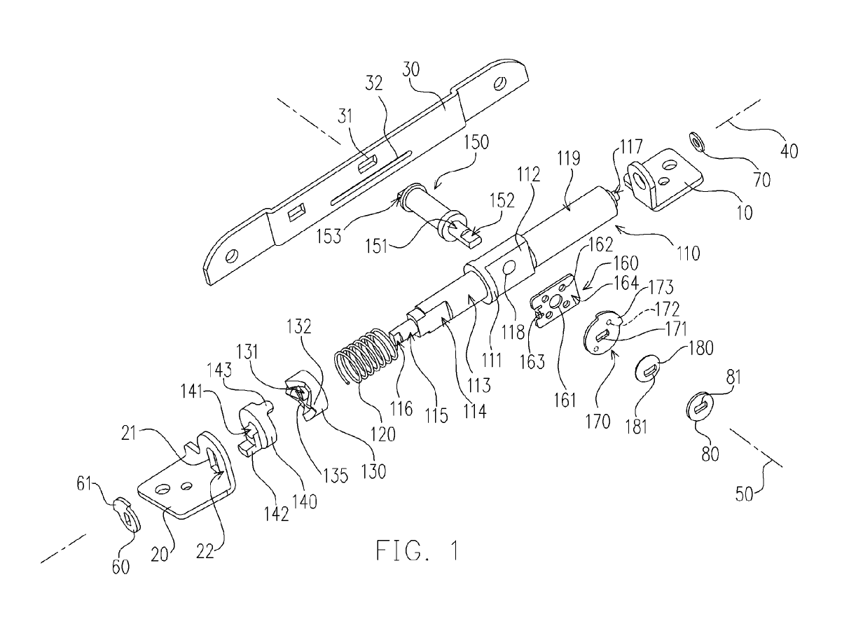

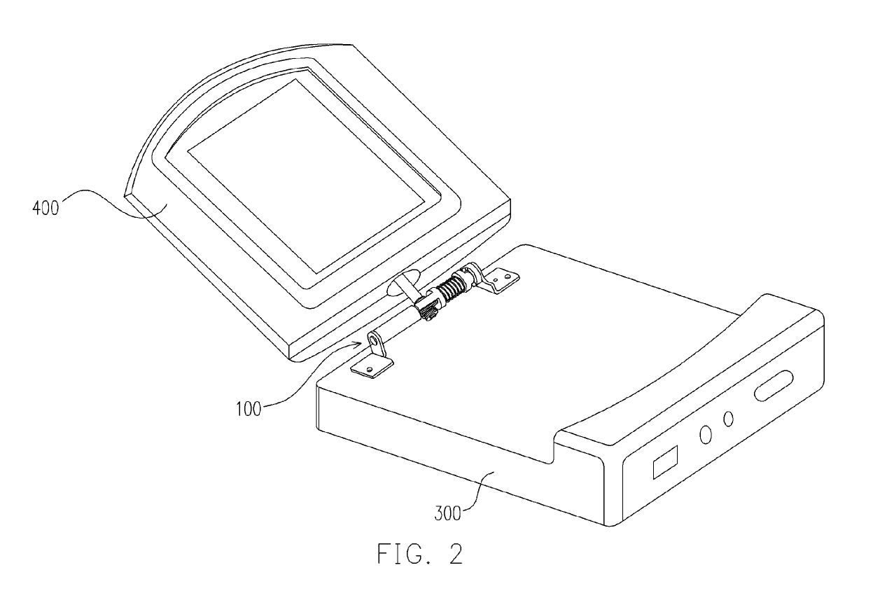

FIG. 1 is a schematic perspective exploded view showing components of a rotary hinge according to a first embodiment of the present invention. FIG. 2 is a schematic perspective view showing a rotary hinge coupling a display panel with an image-capturing device according to a first embodiment of the present invention. Referring to FIGS. 1 and 2, a rotary hinge 100 assembled from the components shown in FIG. 1 may be suited for rotationally coupling a display panel 400 with a image-capturing device 300, for example. The rotary hinge 100 includes two supporting frames 10 and 20 adapted to be jointed with the image-capturing device 300 and another supporting frame 30 adapted to be jointed with the display panel 400.

Referring to FIG. 1, the rotary hinge 100 includes an axially extending pivot 110 having two ends rotationally mounted to the supporting frames 10 and 20 respectively. The pivot 110 has a spring stop 111 and a pedestal 112 that are positioned at a central region of the pivot 110, for example. In the embodiment, the pedestal 112 is positioned adjacent to a side of the spring stop 111.

The rotary hinge 110 further includes a spring 120 mounted around a left-side axle portion 113 of the pivot 110 and withstood by the spring stop 111. The rotary hinge 100 further includes two ratchet wheels 130 and 140 axially mounted on reduced portions 114 and 115 of the pivot 110 respectively with the pivot 110 extending through holes 131 and 141 of the ratchet wheels 130 and 140 respectively. The ratchet wheel 130 can slide on the reduced portion 114 of the pivot 110 in an axial direction of the pivot 110. The ratchet wheel 140 has a rotation stop 142 inserted into a hole 21 of the supporting frame 20 to fix the ratchet wheel 140 on the supporting frame 102. The spring 120 is compressed between the spring stop 111 and the ratchet wheel 130. Typically, the ratchet wheels 130 and 140 contact with each other by the pressing action of the spring 120. It should be noted that when the pivot 110 is being rotated about the axis 40, the ratchet wheel 130 is being rotated about the axis 40 in response to the rotation of the pivot 110, but the ratchet wheel 140 does not rotate about the axis 40 due to the rotation stop 142 of the ratchet wheel 140 being inserted into the hole 21 of the supporting frame 20.

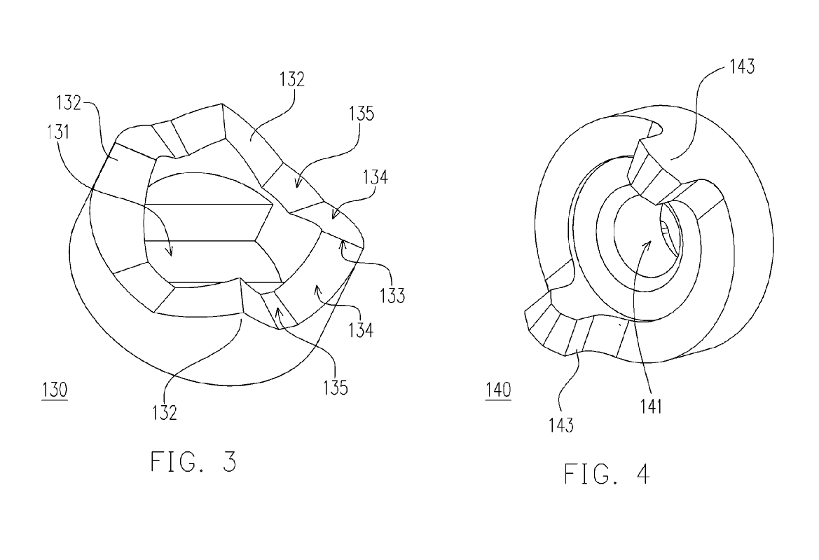

FIG. 3 is a schematic perspective magnified view showing the ratchet wheel 130 according to a first embodiment of the present invention. Referring to FIGS. 1 and 3, the ratchet wheel 130 has an annular region, multiple protrusions 132, and multiple angular positioning stands 135. The protrusions 132 project from the annular region in the axial direction of the pivot 110. The angular positioning stands 135 are positioned at the lowest zones on the annular region between the protrusions 132 of the ratchet wheel 130. In the embodiment, each of the protrusions 132 has a sharp tip 133 and two inclined surfaces 134, wherein the inclined surfaces 134 are formed at both opposite of the sharp tip 133.

FIG. 4 is a schematic perspective magnified view showing the ratchet wheel 140 according to a first embodiment of the present invention. Referring to FIGS. 1 and 4, the ratchet wheel 140 has an annular region and two protrusions 143. The protrusions 143 project from the annular region in the axial direction of said pivot 110.

Referring to FIGS. 1-4, the ratchet wheel 130 can rotate about the axis 40 relative to the ratchet wheel 140 with the protrusions 132 of the ratchet wheel 130 rotating over the annular region of the ratchet wheel 140 and with the protrusions 143 of the ratchet wheel 140 rotating over the annular region of the ratchet wheel 130. If the protrusions 143 of the ratchet wheel 140 are located on the inclined surfaces 134 of the protrusions 132 of the ratchet wheel 130, the ratchet wheel 130 will be rotated with the pressing of the spring 120 until the protrusions 143 of the ratchet wheel 140 are located on the angular positioning stands 135 of the ratchet wheel 130. Therefore, the ratchet wheel 130 can be automatically rotated to a stable condition that the display panel 400 will not rotate relative to the image-capturing device 300 without an external force. Moreover, rotating the display panel 400 relative to the image-capturing device 300 can be automatically stopped at some predetermined angles depending on where the protrusions 132 are positioned on the annular region of the ratchet wheel 130. The ratchet wheel 130 can act a reciprocal movement on the pivot 110 in the axial direction of the pivot 110 when the pivot 110 is rotated with the protrusions 143 of the ratchet wheel 140 moving on the protrusions 132 of the ratchet wheel 130 or moving to the region between the protrusions 132 of the ratchet wheel 130. Accordingly, the action between the ratchet wheels 130 and 140 finds a user rotating the display panel 400 about the axis 40 relative to the image-capturing device 300 with a click feeling.

In the embodiment, when the display penal 200 is rotated at angles, such as 90 degrees and 140 degrees, with respect to the image capturing device 300, the protrusions 143 of the ratchet wheel 140 are positioned on the angular positioning stands 135 of the ratchet wheel 130. When the display penal 200 is rotated at angles, such as 45 degrees and 115 degrees, with respect to the image capturing device 300, the protrusions 143 of the ratchet wheel 140 are positioned on the sharp tips 133 of the protrusions 132 of the ratchet wheel 130. If a user rotates the display panel 400 at an angle between 0 degrees and 45 degrees with respect to the image-capturing device 300, the display panel 400 will be automatically rotated with the pressing of the spring 120 and stop at 0 degrees with respect to the image-capturing device 300. If a user rotates the display panel 400 at an angle between 45 degrees and 115 degrees with respect to the image-capturing device 300, the display panel 400 will be automatically rotated with the pressing of the spring 120 and stop at 90 degrees with respect to the image-capturing device 300. If a user rotates the display panel 400 at an angle between 115 degrees and 140 degrees with respect to the image-capturing device 300, the display panel 400 will be automatically rotated with under the pressing of the spring 120 and stop at 140 degrees with respect to the image-capturing device 300.

Referring to FIG. 1, the rotary hinge 100 includes two fasteners 60 and 70 affixed to the two distal portions 116 and 117 of the pivot 110 by riveting, for example. The fasteners 60 and 70 are suitable for securing the pivot 110 onto the supporting frames 20 and 10, respectively. The fastener 60 has a rotation stop 61 at the peripheral region thereof. The rotation stop 142 of the ratchet wheel 140 extends through the hole 21 of the supporting frame 20 and protrudes from a surface 22 of the supporting frame 20 in an axial direction of the pivot 110. When the pivot 110 is being rotated about the axis 40, the rotation stop 61 is being rotated over the surface 22 of the supporting frame 20 about the axis 40 but the rotation stop 142 of the ratchet wheel 140 does not rotate about the axis 40. The rotation stop 142 prevents the pivot 110 from being rotated forwardly with the rotation stop 61 of the fastener 60 contacting with the rotation stop 142 of the ratchet wheel 140.

Referring to FIG. 1, the rotary hinge 100 further includes another axially extending pivot 150, two plates 160 and 170, a resilient reservoir 180, such as disk spring, and a fastener 80. The pivot 150 has a cylinder portion 151 extending through a hole 18 in the pedestal 112 of the pivot 110 and further extending through a hole 161 in the plate 160, and a reduced portion 152 extending through a hole 171 in the plate 170, a hole 181 in the disk spring 180 and a hole 81 in the fastener 80. The plates 160 and 170, the disk spring 180 and the fastener 80 are sequentially mounted over the pedestal 112 of the pivot 110. The fastener 80 is jointed with the reduced portion 152 of the pivot 150 by riveting, for example, to secure the plates 160 and 170 and the disk spring 180 over the pedestal 112 of the pivot 110 and to secure the pivots 110 and 150.

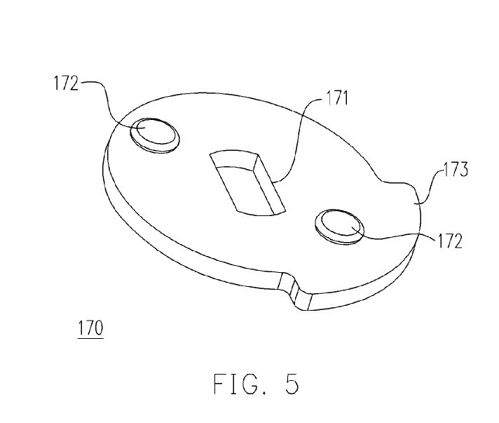

Referring to FIG. 1, when the pivot 150 is being rotated about the axis 50, the plate 170 is being rotated about the axis 50 in response to the rotation of the pivot 150, but the plate 160 does not rotate about the axis 50. The spring stop 111 and a right-side axle portion 119 of the pivot 110 are positioned at two corresponding sides of the plate 160 and can avoid the rotation of the plate 160. The plate 160 has multiple angular positioning holes 162 and the plate 170 has two protrusions 172 projecting from a surface of the plate 170 in an axial direction of the pivot 150, as shown in FIG. 5. FIG. 5 is a schematic perspective magnified view showing the plate 170 according to a first embodiment of the present invention. The protrusions 172 of the plate 170 can be rotated over the plate 160 in response to the rotation of the pivot 150, or can be inserted into two of the angular positioning holes 162 of the plate 160 with the pressing of the disk spring 180. Therefore, the rotation of the display panel 400 about the pivot 150 can be stopped in a stable condition that the protrusions 172 of the plate 170 are inserted into two of the angular positioning holes 162 and can be stopped at some predetermined angles depending on where the angular positioning holes 162 are positioned in the plate 160. Moreover, the action between the plates 160 and 170 finds a user rotating the display panel 400 about the pivot 150 with a click feeling. In the first embodiment, when the pivot 150 is rotated at every 90 degrees (0.degree., 90.degree., 180.degree. and 270.degree.), the protrusions 172 are inserted into the angular positioning holes 162.

Furthermore, referring to FIG. 1, the plate 160 has a rotation stop 163 protruding from a surface 164 of the plate 160 and the plate 170 has a rotation stop 173 at a peripheral region thereof. When the pivot 150 is being rotated about the axis 50, the rotation stop 173 is being rotated over the surface 164 of the plate 160 in response to the rotation of the pivot 150, and the rotation stop 163 does not rotate relative to the plate 160. The rotation stop 163 of the plate 160 prevents the pivot 150 from being rotated forwardly with the rotation stop 173 of the plate 170 contacting with the rotation stop 163 of the plate 160.

Referring to FIG. 1, the pivot 150 has a distal portion 153 extending through a hole 31 of the supporting frame 30 and capable of being jointed with the supporting frame 30 by riveting, for example. The supporting frame 30 can be coupled with the display panel 400. A cable (not shown) electrically connecting the display panel 400 to the image-capturing device 300 can pass through a slot 32 of the supporting frame 30 and can be wound around the right-side axle portion 119 of the pivot 110.

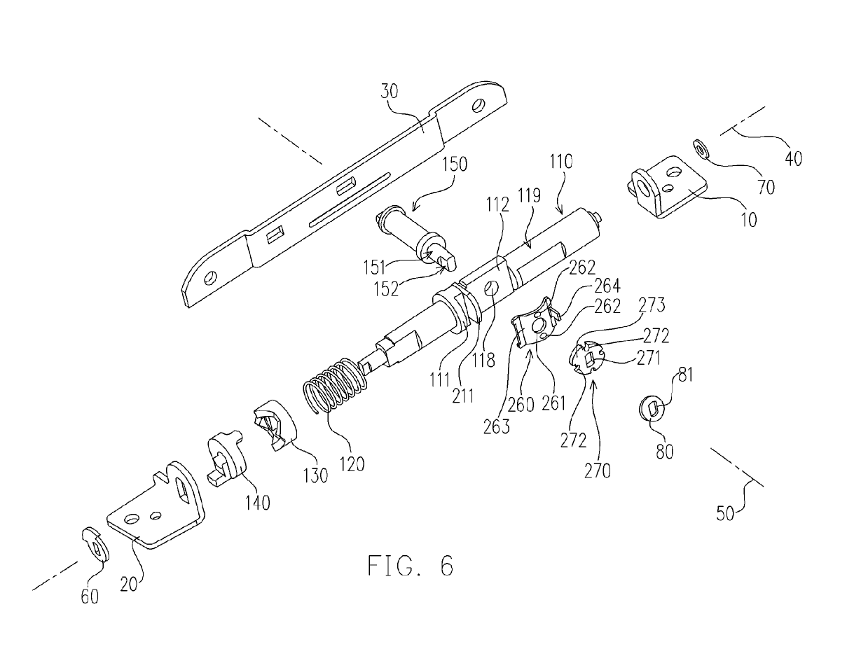

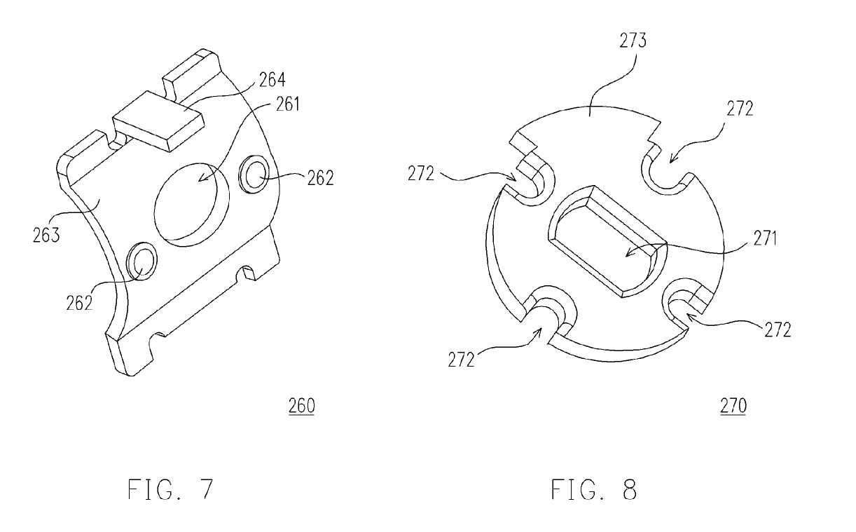

### Second Embodiment

Wherever possible, the same reference numbers are used in the drawings and the description to refer to the same or like parts in accordance with the first embodiment and the second embodiment. FIG. 6 is a schematic perspective view showing a rotary hinge coupling a display panel with an image-capturing device according to a second embodiment of the present invention. FIG. 7 is a schematic perspective magnified view showing a plate 260 according to a second embodiment of the present invention. FIG. 8 is a schematic perspective magnified view showing a plate 270 according to a second embodiment of the present invention.

Referring to FIG. 6, the rotary hinge 200 includes two axially extending pivots 110 and 150. The pivot 110 can be mounted on the supporting frames 10 and 20 that are adapted to be jointed with the image-capturing device 300. A supporting frame 30 mounted on the pivot 150 can be jointed with the display panel 400. The spring 120, the ratchet wheels 130 and 140, and the fasteners 60 and 70 installed on the pivot 110 are similar to the first embodiment and mentioned in the first embodiment. The spring 120 is mounted between the spring stop 111 and the two ratchet wheels 130 and 140.

Referring to FIG. 6, the rotary hinge 200 includes two plates 260 and 270, and a fastener 80. The pivot 150 has a cylinder portion 151 extending through a hole 118 in the pedestal 112 of the pivot 110 and further extending through a hole 261 in the plate 260, and a reduced portion 152 extending through a hole 271 in the plate 270 and a hole 81 in the fastener 80. The plates 260 and 270, and the fastener 80 are sequentially mounted over the pedestal 112 of the pivot 110. The fastener 80 is jointed with the reduced portion 152 of the pivot 150 by riveting, for example, to secure the plates 260 and 270 over the pedestal 112 of the pivot 110 and to secure the pivots 110 and 150.

Referring to FIGS. 6, 7 and 8, when the pivot 150 is being rotated about the axis 50, the plate 270 is being rotated about the axis 50 in response to the rotation of the pivot 150, but the plate 260 does not rotate about the axis 50. A stop 211 of the pivot 110 and a right-side axle portion 119 of the pivot 110 are positioned at two corresponding sides of the plate 260 and can avoid the rotation of the plate 260. The plate 270 has multiple angular positioning holes 272 and the plate 260 has two protrusions 262 projecting from a surface of the plate 270 in an axial direction of the pivot 150. The protrusions 262 of the plate 260 can be rotated over the plate 270 in response to the rotation of the pivot 150, or can be inserted into two of the angular positioning holes 272 of the plate 270 with the pressing of a resilient reservoir. In the second embodiment, the resilient reservoir is provided from the plate 260. The plate 260 may comprise a disk spring 263. However, the resilient reservoir may be provided from another element, such as a singular disk spring or a coil spring can be mounted on the pivot 150 for exerting a resilient force to press the two plates 260 and 270. Therefore, the rotation of the display panel 400 about the pivot 150 can be stopped in a stable condition that the protrusions 262 of the plate 260 are inserted into two of the angular positioning holes 272 and can be stopped at some predetermined angles depending on where the angular positioning holes 272 are positioned in the plate 270. The action between the plates 260 and 270 finds a user rotating the display panel 400 about the pivot 150 with a click feeling. In the second embodiment, when the pivot 150 is rotated at every 90 degrees (0.degree., 90.degree., 180.degree. and 270.degree.), the protrusions 262 are inserted into the angular positioning holes 272.

Furthermore, referring to FIGS. 6, 7 and 8, the plate 260 has a rotation stop 264 protruding from the plate 260 and the plate 270 has a rotation stop 273 at a peripheral region thereof. When the pivot 150 is being rotated about the axis 50, the rotation stop 273 is being rotated relative to the plate 260 in response to the rotation of the pivot 150, and the rotation stop 264 does not rotate relative to the plate 260. The rotation stop 264 of the plate 260 prevents the pivot 150 from being rotated forwardly with the rotation stop 273 of the plate 270 contacting with the rotation stop 264 of the plate 260.

### CONCLOSION

It will be well known to those skilled in the art that the rotary hinge is not limited to rotationally coupling a display panel with a image-capturing device, but the above-mentioned rotary hinge can be employed for coupling whatever devices that require rotationally coupling with each other.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.
What is claimed is:

1. A rotary hinge for rotationally coupling a first device with a second device, comprising:
at least a first supporting frame mounted on said first device;
at least a second supporting frame mounted on said first device;
a first axially extending pivot having two ends rotationally mounted to said first and second supporting frames respectively and having a spring stop and a pedestal;
a first ratchet wheel mounted on said first pivot and capable of sliding in an axial direction of said first pivot, said first ratchet wheel having a first annular region and multiple first protrusions, said first protrusions projecting from said first annular region in the axial direction of said first pivot;
a spring mounted around said first pivot between said spring stop and said first ratchet;
a second ratchet wheel mounted on said first pivot and contacting with said first ratchet wheel, said second ratchet wheel fixed on said second supporting frame, said second ratchet wheel having a second annular region and multiple second protrusions, said second protrusions projecting from said second annular region in the axial direction of said first pivot, said first ratchet wheel capable of rotating relative to said second ratchet wheel with said first protrusions rotating over said second annular region and with said second protrusions rotating over said first annular region such that said first ratchet wheel can act a reciprocal movement on said first pivot in the axial direction of said first pivot when said first pivot is rotated with said first protrusions moving on said second protrusions or moving to the region between said second protrusions;
a second axially extending pivot extending through said first pivot and connecting with said second device;
a first plate mounted on said pedestal of said first pivot, said second pivot extending through said first plate, said first plate having at least a third protrusion projecting from a surface of said first plate in an axial direction of said second pivot; and
a second plate mounted on said first plate and fixed on said second pivot and having multiple angular positioning holes, said third protrusion capable of being rotated over said second plate in response to the rotation of said second pivot or capable of being inserted into at least one of said angular positioning holes of said second plate.

2. The rotary hinge according to claim 1 further comprising a fastener fixed on said first pivot for securing said first pivot on said second supporting frame, wherein said fastener has a first rotation stop, said second ratchet wheel has a second rotation stop extending through a hole of said second supporting frame and protruding from a surface of said second supporting frame in an axial direction of said first pivot, wherein when said first pivot is being rotated, said first rotation stop is being rotated over said surface of said second supporting frame, and said second rotation stop does not rotate relative to said second supporting frame, and said second rotation stop prevents said first pivot from being rotated forwardly with said first rotation stop contacting with said second rotation stop.

3. The rotary hinge according to claim 1, wherein said first plate has a first rotation stop protruding from said first plate, said second plate has a second rotation stop, wherein when said second pivot is being rotated, said second rotation stop is being rotated relative to said first plate, and said first rotation stop does not rotate relative to said first plate, and said first rotation stop prevents said second pivot from being rotated forwardly with said second rotation stop contacting with said first rotation stop.

4. The rotary hinge according to claim 1, wherein said first plate comprises a disk spring.

5. The rotary hinge according to claim 1, wherein said first device comprises an image-capturing device.

6. The rotary hinge according to claim 1, wherein said second device comprises a display panel.

7. The rotary hinge according to claim 1, wherein each of said first protrusions comprises a sharp tip and two inclined surfaces, the inclined surfaces formed at both opposite of the sharp tip.

8. A rotary hinge for rotationally coupling a first device with a second device, comprising:
a first axially extending pivot mounted to said first device and having a spring stop;
a first ratchet wheel mounted on said first pivot and capable of sliding in an axial direction of said first pivot, said first ratchet wheel having a first annular region and multiple first protrusions, said first protrusions projecting from said first annular region in the axial direction of said first pivot;
a spring mounted around said first pivot between said spring stop and said first ratchet;
a second ratchet wheel mounted on said first pivot, said second ratchet wheel contacting with said first ratchet wheel, said second ratchet wheel having a second annular region and multiple second protrusions, said second protrusions projecting from said second annular region in the axial direction of said first pivot, said first ratchet wheel capable of rotating relative to said second ratchet wheel with said first protrusions rotating over said second annular region and with said second protrusions rotating over said first annular region such that said first ratchet wheel can act a reciprocal movement on said first pivot in the axial direction of said first pivot when said first pivot is rotated with said first protrusions moving on said second protrusions or moving to the region between said second protrusions; and
a second axially extending pivot connecting said first pivot with said second device.

9. The rotary hinge according to claim 8 further comprising a fastener fixed on said first pivot for securing said first pivot on a supporting frame mounted on said first device, wherein said fastener has a first rotation stop, said second ratchet wheel has a second rotation stop extending through a hole of said supporting frame and protruding from a surface of said second supporting frame in an axial direction of said first pivot, wherein when said first pivot is being rotated, said first rotation stop is being rotated over said surface of said second supporting frame, and said second rotation stop does not rotate relative to said second supporting frame, and said second rotation stop prevents said first pivot from being rotated forwardly with said first rotation stop contacting with said second rotation stop.

10. The rotary hinge according to claim 8, wherein said first device comprises an image-capturing device.

11. The rotary hinge according to claim 8, wherein said second device comprises a display panel.

12. The rotary hinge according to claim 8, wherein each of said first protrusions comprises a sharp tip and two inclined surfaces, the inclined surfaces formed at both opposite of the sharp tip.

13. A rotary hinge for rotationally coupling a first device with a second device, comprising:
a first axially extending pivot mounted to said first device and having a pedestal;
a second axially extending pivot extending through said first pivot and connecting with said second device;
a first plate mounted on said pedestal of said first pivot and having multiple angular positioning holes, said second pivot extending through said first plate;
a second plate mounted on said first plate and fixed on said second pivot, said second plate having at least a protrusion projecting from a surface of said second plate in an axial direction of said second pivot, said protrusion capable of being rotated over said first plate in response to the rotation of said second pivot or capable of being inserted into at least one of said angular positioning holes of said first plate; and
a resilient reservoir mounted on said second pivot for urging said second plate onto first plate.

14. The rotary hinge according to claim 13, wherein said first plate has a first rotation stop protruding from a surface of said first plate, said second plate has a second rotation stop, wherein when said second pivot is being rotated, said second rotation stop is being rotated over said surface of said first plate, and said first rotation stop does not rotate relative to said first plate, and said first rotation stop prevents said second pivot from being rotated forwardly with said second rotation stop contacting with said first rotation stop.

15. The rotary hinge according to claim 13, wherein said resilient reservoir comprises a disk spring.

16. The rotary hinge according to claim 13, wherein said first device comprises an image-capturing device.

17. The rotary hinge according to claim 13, wherein said second device comprises a display panel.

18. A rotary hinge for rotationally coupling a first device with a second device, comprising:
a first axially extending pivot mounted to said first device and having a pedestal;
a second axially extending pivot extending through said first pivot and connecting with said second device;
a first plate mounted on said pedestal of said first pivot, said second pivot extending through said first plate, said first plate having at least a protrusion projecting from a surface of said first plate in an axial direction of said second pivot; and
a second plate mounted on said first plate and fixed on said second pivot and having multiple angular positioning holes, said protrusion capable of being rotated over said second plate in response to the rotation of said second pivot or capable of being inserted into at least one of said angular positioning holes of said second plate.

19. The rotary hinge according to claim 18, wherein said first plate has a first rotation stop protruding from said first plate, said second plate has a second rotation stop, wherein when said second pivot is being rotated, said second rotation stop is being rotated relative to said first plate, and said first rotation stop does not rotate relative to said first plate, and said first rotation stop prevents said second pivot from being rotated forwardly with said second rotation stop contacting with said first rotation stop.

20. The rotary hinge according to claim 18, wherein said first plate comprises a disk spring.

21. The rotary hinge according to claim 18, wherein said first device comprises an image-capturing device.

22. The rotary hinge according to claim 18, wherein said second device comprises a display panel.
